(19) United States
(12) Patent Application Publication
(10) Pub. No.: US 2015/0090099 A1
(43) Pub. Date: Apr. 2, 2015

(54) Method for Transforming a Poem into a Song

(71) Applicant: David Michael Hawkins, Phoenixville, PA (US)

(72) Inventor: David Michael Hawkins, Phoenixville, PA (US)

(21) Appl. No.: 14/043,713

(22) Filed: Oct. 1, 2013

(51) Int. Cl. G10H 1/00

(52) U.S. Cl. CPC G10H 1/0025; G10H 2210/105
USPC 84/609

(57) ABSTRACT

This invention comprises a method to transform a poem into a song. The client first composes a poem or a passage. Next, the client goes to the “Make Your Poem a Song” website: http:www.makeyourpoemasong.com (hereinafter “MYPS”). The client then populates the unique specification menus on the website. Selections from the specification menus allow the client to mold each and every aspect of the song creation process. After the client selects each song aspect, the MYPS coordinator chooses a composer to write the song based on the song chosen song characteristics. The composer then creates a song based on the characteristics chosen by the client. When the composer has created the “blueprint” of the song, the composer releases a small portion of the song to the client through the MYPS coordinator. The client then has 48 hours to comment on the song. If client has no comment, the composer creates, mixes and masters the song in final form, depending on the package chosen.

### CROSS-REFERENCE TO RELATED APPLICATIONS

This application claims the benefit of a previously filed provisional patent entitled “Method for Transforming a Poem into a Song”, filed Oct. 1, 2012, application No. 61/708,620.

### BACKGROUND OF THE INVENTION

For any special occasion, there is no more personalized of a gift then a personal song written for someone. The inventor has developed a useful, efficient and easy-to-use method for transforming a poem into a song. The invention utilizes descriptive selections from a customized website to guide the musician in the creation. Specialized and precisely descriptive menus from the website form the cornerstone of the inventive process. This is due to the specialization that the client can mold the song to his/her liking, simply by selecting from the specialized menus.

The invented process is an efficient and cost effective method to connect the client's poetic creation with a composer's musical prowess to create a song. The client is able to create a composition that would not be possible without the efficient and effective process developed by the inventor.

### BRIEF SUMMARY OF THE INVENTION

The distinguishing and innovative characteristics of the inventive art are exemplified by the said specification menus that allow the client to choose each unique characteristic of the composed song and allow the composer to gain fundamental insight into the creative selections of the client. The said specification menus truly provide a direct medium between the client and the composer.

The genre menu provides the client with a myriad of choices of type of music (i.e., jazz, latin, rock, etc.) and allows the client to narrow the decade or era of music “sound”. The emotions menu allows the client to pick the overall emotion that the song should take (i.e., evil, heavenly, somber, etc.) and allows the client to express feelings on how the song should feel overall. The sound effects menu allows the client to choose an overall sound effect for the song (i.e., whistle, thunder, bells, etc.) and allows the client to choose a sound effect that is not seen in the menu choices. The instruments menu allows the client to choose the instruments to be used in the song creation and used by the composer to create the song to the specifications chosen by the client in the above menus. The vocals menu lets the client choose how the vocals will sound (i.e., male, female, raspy, etc.)

There are a number of alternative song deliverables that may be chosen by the client and are distinguished by the complexity of the end product. To begin, the client chooses one of the following packages: the acoustic option, the entire service option or the entire service and “you sing it” option.

The acoustic option allows the client to choose from only the genre specification menu, emotions menu, acoustic guitar or piano, and male or female voice. Alternatively, the entire service process option allows the client to make selections from all specification menus and up to six (6) instrument choices.

The client begins by following the method as described in the above section “Detailed Description of the Invention”

### BRIEF DESCRIPTION OF THE SEVERAL VIEWS OF THE DRAWINGS

FIG. 1—FIG. 1 encompasses a detailed overview of the acoustic option process. This is the least expensive option and therefore gives the client the least amount of creative options.

FIG. 2—FIG. 2 encompasses a detailed overview of the entire service option process. This is the standard option and therefore gives the client a standard amount of creative options.

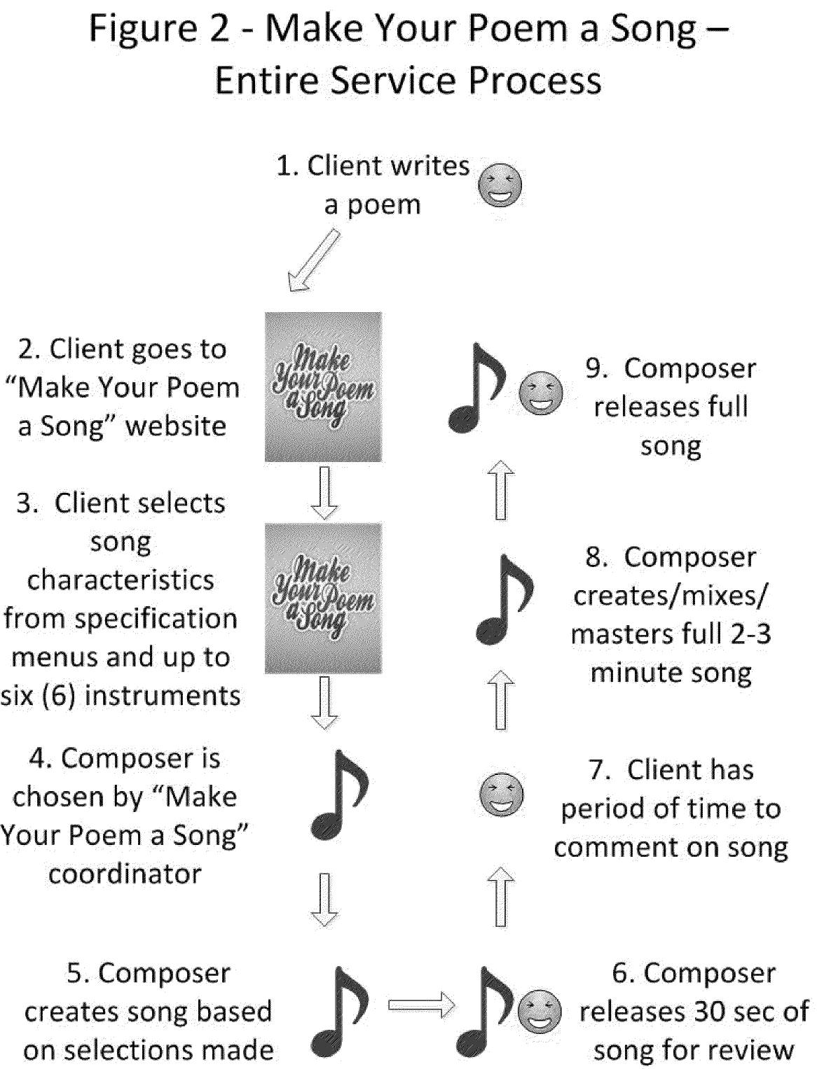

FIG. 3—FIG. 3 encompasses a detailed overview of the entire service and “you sing it” option process. This is an extensive option and therefore gives the client the full amount of creative options.

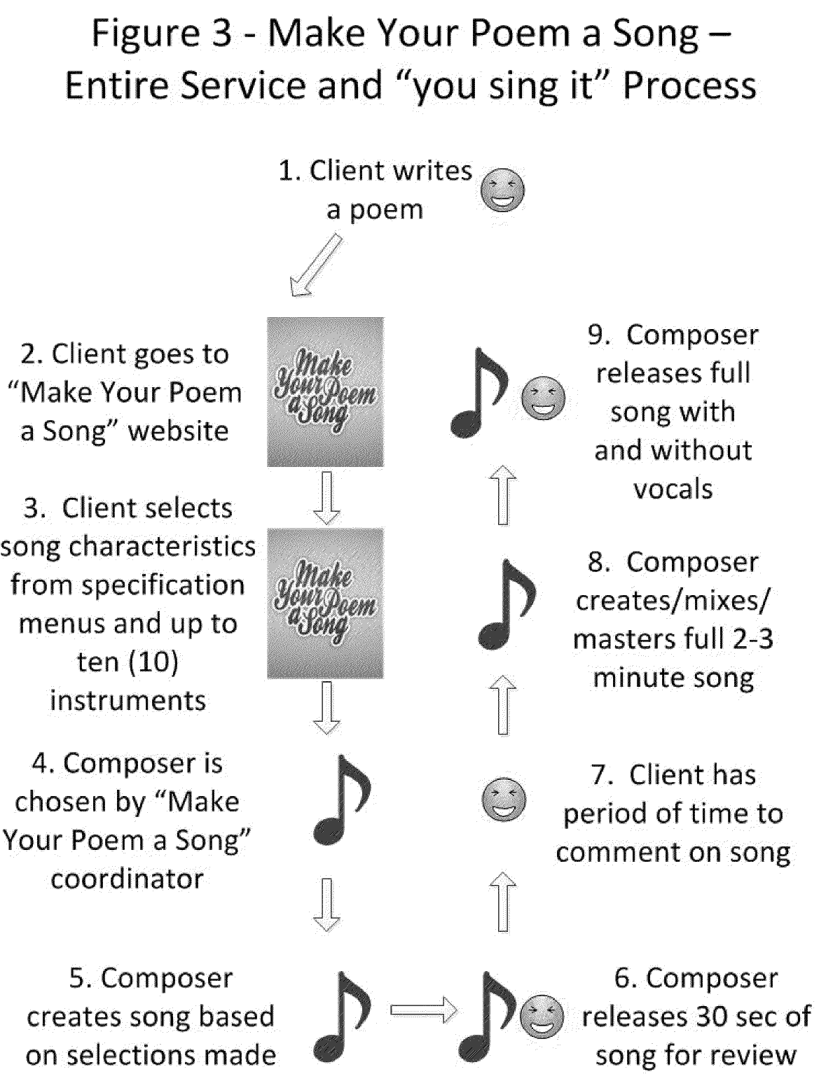

### DETAILED DESCRIPTION OF THE INVENTION

The invention is a method for creating a poem into a song through a facilitator (coordinator) and transfer of the creative moment.

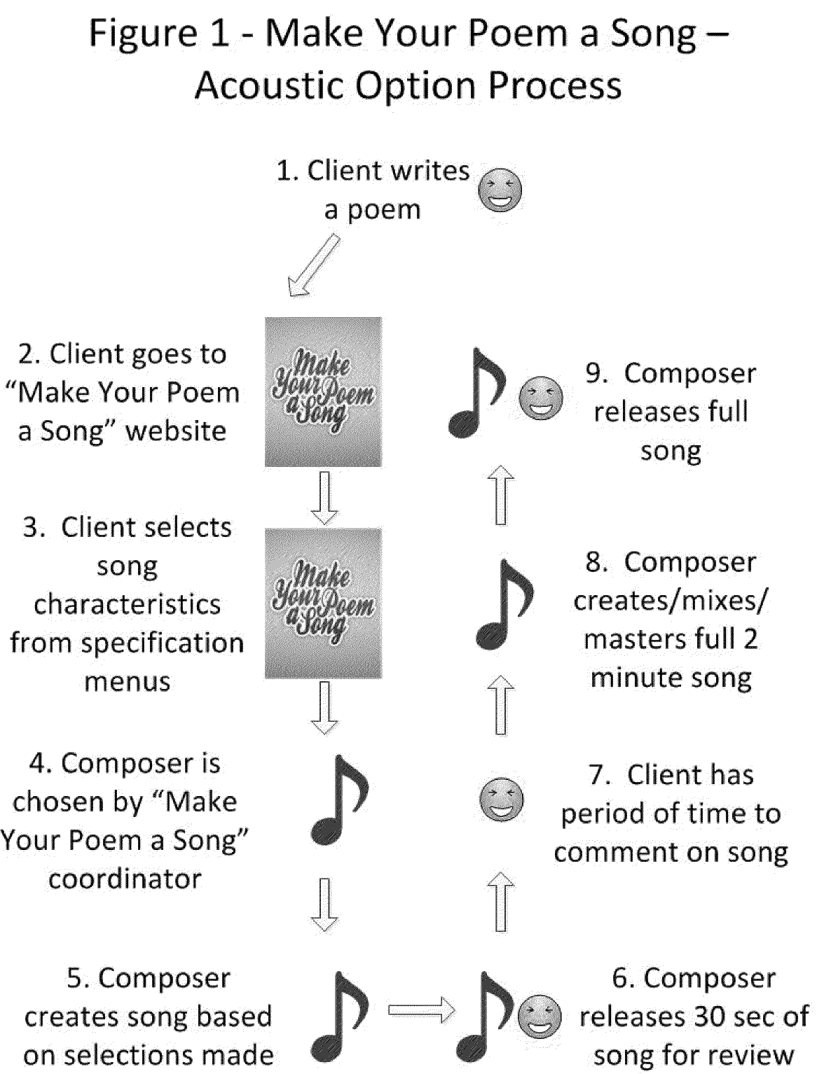

Client first writes a poem that he/she wishes to convert to a song. [#1, FIG. 1]

Next, the client goes to the “Make Your Poem a Song” website. [#2, FIG. 1]

Client chooses a song option: acoustic option, entire service option and entire service and “you sing it” option.

Client then selects characteristics of the song through a series of specification menus. [#3, FIG. 1]

A composer is chosen by “Make Your Poem a Song” coordinator. [#4, FIG. 1]

Chosen composer creates song based on selections made on specification menus. [#5, FIG. 1]

Composer releases 30 seconds of song to client for review. [#6, FIG. 1]

Client has 48 hours to comment on song. [#7, FIG. 1]

Composer creates, mixes and masters a full 2 minute song within 30 days. [#8, FIG. 1]

Composer releases full song to client. [#9, FIG. 1]

1. A method for making a poem into a song comprising the steps of:
a. submitting a creative work to a process coordinator,
b. process coordinator choosing song characteristics from descriptive options presented
c. process coordinator choosing a song composer based on the descriptive options chosen and the creative work presented
d. process coordinator choosing a musician based on the descriptive options chosen and the creative work presented
e. composer creating song based on descriptive options chosen and the creative work presented
f. composer coordinating with musician to record song created by composer
g. musician creating final song product
h. releasing final song product to creative work submitter.

2. The method in claim 1 wherein the creative work is a poem.

3. The method in claim 1 wherein the creative work is a passage.

4. The method in claim 1 wherein the creative work is a spoken story or passage.

5. The method of claim 1 wherein the creative work is a picture.

6. The method of claim 1 wherein the creative work is a video.

7. The method of claim 1 wherein the composer and the musician are one person.

8. The method of claim 1 wherein the composer is a videographer.

9. The method of claim 1 wherein the musician is a videographer.

10. The method of claim 1 wherein the final song product is a video with soundtrack.
